(19) United States
(12) Patent Application Publication
(10) Pub. No.: US 2021/0174471 A1
(43) Pub. Date: Jun. 10, 2021

(54) Image Stitching Method, Electronic Apparatus, and Storage Medium

(71) Applicant: Shanghai SenseTime Intelligent Technology Co., Ltd., Shanghai (CN)

(72) Inventors: Xin Kuang, Shanghai (CN); Ningyuan Mao, Shanghai (CN); Qingzheng Li, Shanghai (CN)

(73) Assignee: Shanghai SenseTime Intelligent Technology Co., Ltd., Shanghai (CN)

(21) Appl. No.: 17/172,267

(22) Filed: Feb. 10, 2021

Related U.S. Application Data
(63) Continuation of application No. PCT/CN2019/098546, filed on Jul. 31, 2019.

(30) Foreign Application Priority Data
Aug. 29, 2018 (CN) 201810998634.9

(51) Int. Cl. G06T 3/40; G06T 5/00; G06T 5/50; B60R 1/00

(52) U.S. Cl. CPC G06T 3/4038; G06T 5/009; G06T 5/50; G06T 2207/30252; B60R 2300/304; B60R 2300/105; B60R 1/00

(57) ABSTRACT

The examples of the present disclosure provide an image stitching method and device, an on-board image processing device, an electronic apparatus, and a storage medium. The image stitching method comprises: acquiring brightness compensation information of each of a plurality of input images to be stitched, the plurality of input images being correspondingly captured by a plurality of cameras arranged on different parts of an apparatus; performing brightness compensation on input images based on the brightness compensation information of each input image; and stitching the input images subjected to the brightness compensation to obtain a stitched image. The examples are capable of alleviating stitching trace in the stitched image that arises from light difference and exposure difference between the cameras, thereby enhancing the visual effect of the stitched image, conducive to effects of various applications that are based on the stitched image.

### CROSS-REFERENCE TO RELATED APPLICATION

This application is a continuation of and claims priority under 35 U.S.C. 120 to PCT Application. No. PCT/CN2019/098546, filed on Jul. 31, 2019, which claims priority to Chinese Patent Application No. CN201810998634.9, filed on Aug. 29, 2018, titled “IMAGE STITCHING METHOD AND DEVICE, ON-BOARD IMAGE PROCESSING DEVICE, ELECTRONIC APPARATUS, AND STORAGE MEDIUM”. All the above-referenced priority documents are incorporated herein by reference in their entirety.

### TECHNICAL FIELD

The present disclosure relates to the field of image processing, in particular, to an image stitching method and device, an on-board image processing device, an electronic apparatus, and a storage medium.

### BACKGROUND

As an important part of the Advanced Driver Assistance System (ADAS), the panorama stitching system can display the scene around the vehicle to the driver or to the intelligent decision-making system in real time. The existing panorama stitching system generally includes cameras that are installed in multiple directions around the vehicle body to capture images around the vehicle body, and combines the captured images to form a 360-degree panoramic image to be presented to the driver or intelligent decision-making system.

### SUMMARY

The present disclosure provides a panorama stitching technical solution.

A first aspect of the present disclosure provides an image stitching method, the method comprising:

acquiring brightness compensation information of each of a plurality of input images to be stitched, the plurality of input images being correspondingly captured by a plurality of cameras arranged on different parts of an apparatus;

performing brightness compensation on input images based on the brightness compensation information of each input image; and

stitching the input images subjected to the brightness compensation to obtain a stitched image.

Another aspect of the present disclosure provides an image stitching device, the device comprising:

a first acquisition module configured to acquire brightness compensation information of each of a plurality of input images to be stitched, the plurality of input images being correspondingly captured by a plurality of cameras;

a compensation module configured to perform brightness compensation on input images based on the brightness compensation information of each input image; and

a stitching module configured to stitch the input images subjected to the brightness compensation to obtain a stitched image.

Still another aspect of the present disclosure provides an on-board image processing device, the device comprising:

a first storage module configured to store a stitching information table and a plurality of input images correspondingly captured by a plurality of cameras; and

a computation chip configured to acquire, from the first storage module, brightness compensation information of each of the plurality of input images to be stitched; acquire from the first storage module, for each output sub-block, an input image block in an input image corresponding to the output sub-block; perform, based on brightness compensation information of an input image where the input image block is located, brightness compensation on the input image block; acquire, based on the input image block subjected to the brightness compensation, output image blocks on the output sub-blocks, and write the acquired output image blocks in sequence back into the first storage module; and obtain the stitched image, in response to writing all the output image blocks of the stitched image corresponding to the stitching information table back into a memory.

Another aspect of the present disclosure provides an electronic apparatus, the apparatus comprising:

a memory configured to store a computer program; and

a processor configured to execute the computer program stored in the memory, and to implement, when the computer program is executed, the method according to any one of examples of the present disclosure.

Still another aspect of the present disclosure provides a computer-readable storage medium on which a computer program is stored, wherein when the computer program is executed by a processor, the method according to any one of examples of the present disclosure is implemented.

According to an image stitching method and device, an on-board image processing device, an electronic apparatus, and a storage medium that are provided by examples of the present disclosure, in order to stitch a plurality of input images correspondingly captured by a plurality of cameras to be stitched, brightness compensation information of each of the plurality of input images to be stitched is acquired, brightness compensation on input images is performed based on the brightness compensation information of each input image, the input images subjected to the brightness compensation are stitched, and a stitched image is obtained. In examples of the present disclosure, performing brightness compensation on a plurality input images to be stitched realizes overall brightness compensation for the images to be stitched, which can alleviate stitching trace in the stitched image, a result of the difference in brightness of the plurality of input images to be stitched that arises from the difference in light of the environment where the different cameras are located and from the exposure difference between the cameras. Thus, the visual effect of the stitched image is enhanced, conducive to effects of various applications that are based on the stitched image. For example, when an example of the present disclosure is applied to a vehicle, the stitched image acquired for displaying the driving environment of the vehicle helps to improve the accuracy of the intelligent driving control.

The technical solution of the present disclosure will be described in detail with the aid of the accompanying drawings and examples.

### BRIEF DESCRIPTION OF THE DRAWINGS

The drawings, constituting a part of the specification, show examples of the present disclosure and are used to explain the principles of the present disclosure together with the description.

With reference to the accompanying drawings, the present disclosure can be understood more clearly due to the following detailed description.

FIG. 1 is a flowchart of an example of an image stitching method according to the present disclosure.

FIG. 2 is a schematic diagram of an area of a stitched image corresponding to six input images in an example of the present disclosure.

FIG. 3 is a flowchart of another example of an image stitching method according to the present disclosure.

FIG. 4 is a flowchart of still another example of an image stitching method according to the present disclosure.

FIG. 5 is a schematic structural diagram of an example of an image stitching device according to the present disclosure.

FIG. 6 is a schematic structural diagram of another example of an image stitching device according to the present disclosure.

FIG. 7 is a schematic structural diagram of an example of an on-board image processing device according to the present disclosure.

FIG. 8 is a schematic structural diagram of another example of an on-board image processing device according to the present disclosure.

FIG. 9 is a schematic structural diagram of an application example of an electronic apparatus according to the present disclosure.

### DETAILED DESCRIPTION

The following are detailed descriptions of various exemplary examples of the present disclosure with reference the accompanying drawings. Unless otherwise specified, the relative arrangement of components and steps, numerical expressions and numerical values set forth in these examples do not limit the scope of the present disclosure.

It should be appreciated that, in the examples of the present disclosure, the term “a plurality of” refers to two or more than two, and the term “at least one” refers to one, two, or more than two, and to a part or entirety.

It is understandable to a person skilled in the art that the terms “first” and “second,” among other terms, in the examples of the present disclosure are used only to differentiate between different steps, devices, modules, or the like, and do not represent any specific technical meaning, nor do they mean a necessary logical order between them.

It should also be appreciated that any component, data, or structure mentioned in the examples of the present disclosure can generally be understood as one or more unless it is clearly defined or the context teaches the opposite.

It should also be appreciated that the description of the various examples in the present disclosure emphasizes the differences between the various examples, and for conciseness purpose, identical or similar aspects of the examples are not repeated but can be known by referring to some of the examples.

It should be understood that, to make the description easier, the sizes of the various parts shown in the drawings are not drawn in accordance with actual proportional relationships.

The following description of at least one exemplary example is actually only illustrative, and in no way does it serve as a limitation to the present disclosure and its application or use.

The technologies, methods, and devices known to a person skilled in the art may not be discussed in detail, but where appropriate, the technologies, methods, and devices should be regarded as part of the specification.

It should be noted that similar reference numerals and letters indicate similar items in the drawings, and thus once an item is defined in one of the drawings, it does not need to be further discussed in the subsequent drawings.

The term “and/or” herein just means association between associated objects, which means that three relationships exist between the associated objects. For example, “A and/or B” means the three cases that A exists alone, A and B exist at the same time, and B exists alone. Besides, the symbol “/” herein generally indicates an “or” relationship between the associated objects.

The examples of the present disclosure are applicable to electronic devices such as terminal devices, computer systems, and servers, which can operate with many other general-purpose or special-purpose computing systems, environments, or configurations. Examples of well-known terminal devices, computing systems, environments and/or configurations suitable for use with electronic devices such as terminal devices, computer systems, and servers include, but are not limited to, personal computer systems, server computer systems, thin clients, thick clients, handheld or laptop devices, microprocessor-based systems, set-top boxes, programmable consumer electronics, network personal computers, small computer systems, large computer systems, and distributed cloud computing technology environments including any of the above systems, among others.

Electronic devices such as terminal devices, computer systems, and servers can be described in the general context of computer system executable instructions (such as program modules) executed by the computer system. Program modules usually may include routines, programs, object programs, components, logic, data structures, etc., which carry out specific tasks or implement specific abstract data types. Computer systems/servers can be implemented in a distributed cloud computing environment, in which tasks are carried out by remote processing devices linked through a communication network. In a distributed cloud computing environment, program modules may be located on storage media of local or remote computing systems including storage devices.

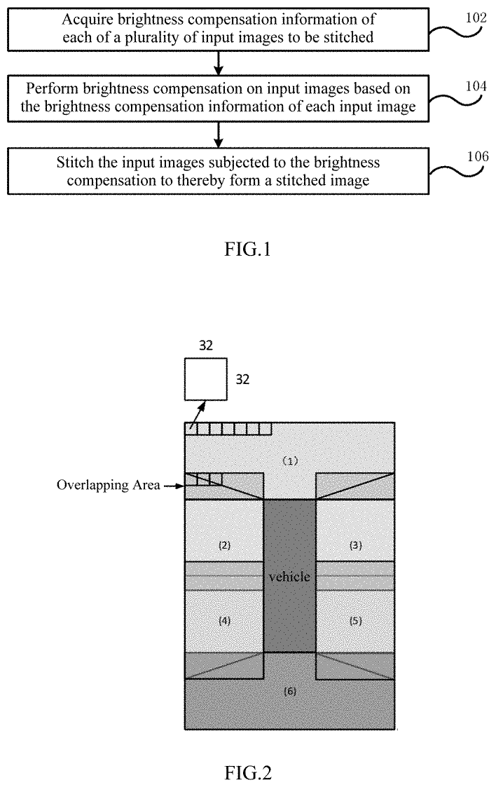

FIG. 1 is a flowchart of an example of an image stitching method according to the present disclosure. As shown in FIG. 1, the image stitching method comprises:

step 102 of acquiring brightness compensation information of each of a plurality of input images to be stitched.

The plurality of input images are correspondingly captured by a plurality of cameras arranged on different parts of an apparatus. The position and direction of the plurality of cameras are such that least two adjacent images or every two adjacent images in the plurality of input images captured by the plurality of cameras have an overlapping area. For example, any two adjacent images have an overlapping area. The adjacent images are images captured by the cameras arranged in adjacent parts among the different parts of the apparatus, or images in the plurality of input images that correspond to an adjacent position of the stitched image.

In the example of the present disclosure, the position and direction of the plurality of cameras are not limited. It is possible to stitch a plurality of input images using the example of the present example, as long as at least two adjacent images or every two adjacent images in the plurality of input images captured by the plurality of cameras have an overlapping area.

In some embodiments of the example, the apparatus in which the plurality of cameras are arranged may be a vehicle, a robot, or any other apparatus that needs to acquire a stitched image, such as other transportation means. When the apparatus in which the plurality of cameras are arranged is a vehicle, the number of the plurality of cameras may be 4 to 8, depending on the length and width of the vehicle and the cameras' field of view to capture the images.

Thus, in some embodiments of the example, the plurality of cameras may include at least one camera arranged at the head position of the vehicle, at least one camera arranged at the rear position of the vehicle, at least one camera arranged at the middle section of one side of the vehicle body, and at least one camera arranged in the middle section of the other side of the vehicle body. Alternatively, the plurality of cameras may include at least one camera arranged at the head position of the vehicle, at least one camera arranged at the rear position of the vehicle, at least two cameras arranged respectively in the front half section and the rear half section of one side of the vehicle body, and at least two cameras respectively arranged in the front half section and the rear half section of the other side of the vehicle body.

For instance, in practical applications, for a long and wide vehicle, two cameras may be set respectively on the head portion, rear portion and both sides of the vehicle: the eight cameras around the vehicle ensure that the vehicle's surrounding can be captured. For a long vehicle, one camera may be set respectively on the head portion and rear portion of the vehicle, and two cameras are set respectively on its both sides; the six cameras ensure that the vehicle's surrounding can be captured. For a vehicle neither long nor wide, one camera may be set respectively on the head portion, rear portion and both sides of the vehicle; the four cameras ensure that the vehicle's surrounding can be captured.

In some embodiments of the example, the plurality of cameras may include at least one fish-eye camera, and/or at least one non-fish-eye camera.

A fish-eye camera is a lens with a focal length of 16 mm or shorter and a viewing angle usually exceeding 90° or even close to or equal to 180°. It is an extremely wide angle lens. With the advantage of a wide viewing angle, the fish-eye camera makes it possible to capture a scene in a wide field of view by arranging fewer cameras.

In an optional example, step 102 may be executed by the processor invoking a corresponding instruction stored in the memory, or by a first acquisition module run by the processor.

The image stitching method further comprises:

step 104 of performing brightness compensation on input images based on the brightness compensation information of each input image.

In the example of the present disclosure, performing brightness compensation on images means adjusting pixel values of pixels in the images so as to adjust the visual effect of the images in respect of brightness.

In an optional example, step 104 may be executed by the processor invoking a corresponding instruction stored in the memory, or by a compensation module run by the processor.

The image stitching method further comprises:

step 106 of stitching the input images subjected to the brightness compensation to obtain a stitched image.

In an optional example, step 106 may be executed by the processor invoking a corresponding instruction stored in the memory, or by a stitching module run by the processor.

According to the examples described above, in order to stitch a plurality of input images correspondingly captured by a plurality of cameras, brightness compensation information of each of the plurality of input images to be stitched is acquired, brightness compensation on input images is performed based on the brightness compensation information of each input image, the input images subjected to the brightness compensation are stitched, and a stitched image is obtained. In the examples of the present disclosure, performing brightness compensation on a plurality input images to be stitched realizes overall brightness compensation for the images to be stitched, which can alleviate stitching trace in the stitched image due to the difference in brightness of the plurality of input images to be stitched that arises from the difference in light of the environment where the different cameras are located and from the exposure difference between the cameras. Thus, the visual effect of the stitched image is enhanced, conducive to effects of various applications that are based on the stitched image. For example, when an example of the present disclosure is applied to a vehicle, the stitched image acquired for displaying the driving environment of the vehicle helps to improve the accuracy of the intelligent driving control.

In some embodiments of the example, step 102 may comprise: determining brightness compensation information of each of the plurality of input images based on an overlapping area in the plurality of input images.

In some embodiments of the example, the brightness compensation information of each input image is used such that the brightness difference between the plurality of input images subjected to the brightness compensation falls within a preset brightness tolerance range.

Alternatively, in some embodiments of the example, the brightness compensation information of each input image is used such that the sum of the differences in pixel values between every two input images in the overlapping area subjected to the brightness compensation is minimum or less than a preset error value.

Since the overlapping area is an area with the same object, the brightness of one area is comparable to that of another. In the example of the present disclosure, determining the brightness compensation information of the input images based on the overlapping area makes the determination accurate. That the brightness difference between the plurality of input images subjected to the brightness compensation falls within a preset brightness tolerance range, or that the sum of the differences in pixel values between every two input images in the overlapping area is minimum or less than a preset error value can alleviate or avoid stitching trace in the overlapping area due to the difference in light of the environment and the exposure difference between the cameras for the plurality of input images to be stitched. Thus, the visual effect of the stitched image is enhanced.

In some embodiments of the example, step 104 may comprise:

acquiring, for each output sub-block in an output area, an input image block in an input image corresponding to an output sub-block, wherein if an input image block corresponding to the output sub-block belongs to an overlapping area of adjacent input images, then input image blocks in all input images that correspond to the output sub-blocks and have the overlapping area are acquired so that the input image blocks in the overlapping area are superimposed and stitched; and

performing, based on brightness compensation information of an input image where an input image block subjected to the brightness compensation is located, brightness compensation on the input image block.

In the example of the present disclosure, the output area refers to an output area of the stitched image, and the output sub-block is a sub-block in the output area. FIG. 2 is a schematic diagram of an area of a stitched image corresponding to six input images in an example of the present disclosure. The six input images in FIG. 2 correspond to output areas (1)-(6) of the stitched image. The six input images are captured by cameras surrounding the vehicle (e.g., cameras distributed in the front section, the rear section, the front middle section on the left side, the rear middle section on the left side, and the front middle section on the right side, and the rear middle section on the right side of the vehicle).

In an optional example, the output sub-block may be a square, and the side length of the output sub-block may be 2 to the power of N. For example, in FIG. 2, the size of the output sub-block is 32×32, for facilitating subsequent calculations.

In an example of the present disclosure, the size unit of the input sub-block, the output sub-block, the input image block, and the output image block may be pixels in order for image data to be read and processed conveniently.

In some optional examples, acquiring an input image block in an input image corresponding to the output sub-blocks may be implemented by:

acquiring position information of the input image block in the input image corresponding to coordinate information of the output sub-block, wherein the position information may include, for example, the size and offset address of the input image block, and the position of the input image block in the input image can be determined based on the size and offset address of the input image block; and

acquiring, based on the position information of the input image block, the input image block from the corresponding input image.

Since an image has the three channels of red, green and blue (RGB), in some embodiments of the present disclosure each channel of each input image has one piece of brightness compensation information. On each channel, brightness compensation information of a plurality of input images to be stitched forms a set of brightness compensation information of the channel. Correspondingly, in this embodiment, performing, based on brightness compensation information of an input image where an input image block is located, brightness compensation on the input image block may comprise: performing, for each channel of an input image block, multiplication processing on pixel values in a channel of each pixel in the input image block by brightness compensation information in the channel of the input image, that is, multiplying pixel values in a channel of each pixel in the input image block by brightness compensation information in the channel of an input image where the input image block is located.

In another example of the present disclosure, performing, based on brightness compensation information of an input image where an input image block is located, brightness compensation on the input image block may be followed by: acquiring, based on the input image block subjected to the brightness compensation, output image block on the output sub-blocks.

Correspondingly, in this example, stitching the input images subjected to the brightness compensation to obtain a stitched image may comprise: stitching the output image blocks to obtain a stitched image.

In some embodiments of the example, acquiring, based on the input image block subjected to the brightness compensation, output image block on the output sub-blocks may comprise:

based on a coordinate of each pixel in the output sub-block and a coordinate in a corresponding input image block, performing interpolation on the corresponding input image block through an interpolation algorithm (e.g., bilinear interpolation algorithm) to obtain output image blocks on the output sub-blocks. The example of the present disclosure does not limit details of how to implement the interpolation algorithm.

For example, it is determinable, from a coordinate of each pixel in the output sub-block and a coordinate in a corresponding input image block, that coordinates of four associated pixels in the input image block corresponding to target pixel 1 in the output sub-block are: x(n)y(m), x(n+1)y(m), x(n)y(m+1), and x(n+1)y(m+1). It is possible to calculate a pixel value of target pixel 1 on the output image using the bilinear interpolation algorithm in the input image block based on pixel values of pixels on the four coordinates. Performing interpolation processing based on a pixel value of a corresponding pixel makes a pixel value of a target pixel more accurate and makes the output image more faithful.

If an input image block in an input image corresponding to the output sub-block belongs to an overlapping area, performing interpolation on the input image block to obtain output image blocks may comprise: performing interpolation on each of the input image blocks corresponding to the output sub-blocks, and superimposing all the interpolated input image blocks corresponding to the output sub-blocks, to obtain output image blocks

In some optional examples, superimposing all the interpolated input image blocks corresponding to the output sub-blocks may comprise:

acquiring, for each channel of each of the interpolated input image blocks, an average, a weighted value, or a weighted average of pixel values of each pixel in at least two different resolutions, wherein the at least two different resolutions include: the resolution of the interpolated input image block and at least one resolution lower than the resolution of the interpolated input image block. For example, if the resolution of the interpolated input image block is 32×32, the at least two different resolutions may include 32×32, 16×16, 8×8, and 4×4. That is, an average, a weighted value, or a weighted average of pixel values of each pixel at the resolutions of 32×32, 16×16, 8×8, and 4×4 is to be acquired. The average of pixel values of one pixel at the resolutions of 32×32, 16×16, 8×8 and 4×4 is the average of the sum of pixel values of the pixel at the resolutions of 32×32, 16×16, 8×8 and 4×4. Assume that the weighting coefficients of pixel values of one pixel at the resolutions of 32×32, 16×16, 8×8, and 4×4 are A, B, C, D. Then, the weighted value of pixel values of one pixel at the resolutions of 32×32, 16×16, 8×8 and 4×4 is the sum of the pixel values of the pixel at the resolutions of 32×32, 16×16, 8×8, and 4×4 multiplied by the corresponding weighting coefficients of A, B, C, and D. The weighted average of pixel values of one pixel at the resolutions of 32×32, 16×16, 8×8 and 4×4 is a result of averaging the sum of the pixel values of the pixel at the resolutions of 32×32, 16×16, 8×8, and 4×4 multiplied by the corresponding weighting coefficients of A, B, C, and D.

Superimposing all the interpolated input image blocks corresponding to the output sub-blocks may further comprise:

for each channel of all the interpolated input image blocks corresponding to the output sub-blocks, performing weighted superposition in accordance with the average value, the weighted value, or the weighted average of the pixel values of each pixel, wherein the weighted superposition refers to multiplying the average, the weighted value, or the weighted average value of pixel values of each pixel by a corresponding preset weighting coefficient, respectively, and superimposing the products.

According to the examples described above, for an overlapping area, superimposing all the interpolated input image blocks corresponding to the output sub-blocks may be carried out by performing weighted superposition in accordance with the average value, the weighted value, or the weighted average of pixel values of each pixel, which alleviates a stitching seam produced by the overlapping area and thus optimizes the display effect.

In an example of the present disclosure, the image stitching method may comprise: acquiring fusion transformation information based on various transformation information from the plurality of images correspondingly captured by the plurality of cameras to the stitched image, wherein the various transformation information may include lens distortion removal information, viewing angle transformation information, and registration information.

The lens distortion removal information includes fish-eye distortion removal information for an input image captured by a fish-eye camera, and/or distortion removal information for an input image captured by a non-fish-eye camera.

There may be distortion in the input image captured by a fisheye camera or a non-fisheye camera, and thus the lens distortion removal information makes it possible to remove distortion in an image captured by the fish-eye camera or the non-fish-eye camera.

In some optional embodiments of the example, the fusion transformation information may be expressed by a fusion transformation function.

The fish-eye distortion removal information, viewing angle transformation information, and registration information will be introduced.

1) Fish-Eye Distortion Removal Information

The fish-eye distortion removal information is used to remove fish-eye distortion in an input image, and it can be expressed by a function known as fish-eye distortion removal function. The coordinate of a pixel in an input image subjected to fish-eye distortion removal based on a fish-eye distortion removal function may be expressed by formula (1):

p(x1,y1)=f1(x0,y0 (1),

where f1 is a fish-eye distortion removal function.

Subjecting an input image to fish-eye distortion removal pixel by pixel in accordance with formula (1) results in a fish-eye distortion removed image.

Assume that the coordinate of a pixel in an input image to be subjected to fish-eye distortion removal is (x0, y0). Then the radius r is represented by formula (2):

r=\sqrt{x0²+y0²} (2).

First, the reverse amplification function M is calculated using formula (3):

$$M = \frac{1}{3 k {r}^{2} W} - W , \qquad ( 3 )$$

where:

$$w = 3 \sqrt{\sqrt{\frac{1}{4 {( {kr}^{2} )}^{2}} + \frac{1}{27 {( {kr}^{2} )}^{3}}} - \frac{1}{2 {kr}^{2}}} , \qquad ( 4 )$$

where k is a constant concerning the degree of distortion of the camera, and may be determined based on the angle of the wide-angle lens of the camera.

The coordinate of the pixel subjected to fish-eye distortion removal by the fish-eye distortion removal function may be as follows:

$$\{ \begin{matrix}x 1 = x 0 * M \\ y 1 = y 0 * M\end{matrix} . \qquad ( 5 )$$

2) Viewing Angle Transformation Information

The viewing angle of a stitched image is generally an angle of top view, an angle of front view, or an angle of back view. viewing angle transformation information can be used to perform viewing angle transformation on an image subjected to fish-eye distortion removal such that the fish-eye distortion removal image is transformed to a viewing angle for the stitched image. The viewing angle transformation information may be expressed by a viewing angle transformation function. After viewing angle transformation is performed on the pixel in the image subjected to fish-eye distortion removal, based on a viewing angle transformation function, the coordinate of the pixel may be expressed by formula (6):

p(x2,y2)=f2(x1,y1) (6),

where f2 is a viewing angle transformation function. Likewise, if the image subjected to fish-eye distortion removal is mapped pixel by pixel in accordance with the transformed coordinates, a corresponding image subjected to viewing angle transformation will be acquired. In an example of the present disclosure, the coordinate mapping relationship of a pixel in the image subjected to viewing angle transformation may be acquired in the following way:

Assume that the coordinate of the pixel in the image to be subjected to viewing angle transformation is (x1, y1), and the three-dimensional coordinate of the pixel subjected to the viewing angle transformation is (x2, y2, z2) and may be expressed by formula (7) and formula (8):

$$\begin{matrix}( \begin{matrix}x 2 \\ y 2 \\ z 2\end{matrix} ) = ( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) ( \begin{matrix}x 1 \\ y 1 \\ 1\end{matrix} ) , and & ( 7 ) \\ x 2 = {a}_{11} x 1 + {a}_{12} y 1 + {a}_{13} \\ y 2 = {a}_{21} x 1 + {a}_{22} y 1 + {a}_{23} \\ z 2 = {a}_{31} x 1 + {a}_{32} y 1 + {a}_{33} . & ( 8 )\end{matrix}$$

Assuming that the coordinate of the pixel in the stitched image is (x,y), and may be expressed by formula (9):

$$x = \frac{x 2}{z 2} = \frac{{a}_{11} x 1 + {a}_{12} y 1 + {a}_{13}}{{a}_{31} x 1 + {a}_{32} y 1 + {a}_{33}} \\ y = \frac{y 2}{z 2} = \frac{{a}_{21} x 1 + {a}_{22} y 1 + {a}_{23}}{{a}_{31} x 1 + {a}_{32} y 1 + {a}_{33}} . \qquad ( 9 )$$

The equations shown in formula (9) have eight unknowns: a11, a12, a13, a21, a22, a23, a31, a32, a33, x and y. The values of the eight unknowns can be acquired based on four sets of mapping relationships between coordinates of a pixel in the image to be subjected to the viewing angle transformation and coordinates of the pixel in the image subjected to the viewing angle transformation.

3) Registration Information

During image stitching, every two of images subjected to viewing angle transformation that have an overlapping area need to be spatially registered. In the case of stitching a plurality of input images, image subjected to viewing angle transformation corresponding to any one of the plurality of input images is selected as a reference, and this reference and another image subjected to viewing angle transformation that has an overlapping area with the reference are registered; then the other image subjected to registration is selected as a reference, and this reference and still another image that has an overlapping area with the reference are registered; and so on. In registering two images having an overlapping area, a preset feature extraction algorithm, for example, the Scale Invariant Feature Transform (SIFT) algorithm, may be used to extract feature points of the overlapping area. A preset feature extraction algorithm, e.g., the Random Sample Consensus (RANSAC) algorithm is used to pair feature points of the two images (in general, there are a plurality of pairs of feature points), and then the affine transformation matrix

$$( \begin{matrix}{b}_{11} & {b}_{12} & {b}_{13} \\ {b}_{21} & {b}_{22} & {b}_{23}\end{matrix} )$$

from non-reference image to reference image among the two images is calculated using the coordinates of the paired points.

In some examples of the present disclosure, the registration information may be expressed by a registration function, based on which the mapping relationship between the coordinate of a pixel in the non-reference image and its coordinate in the reference image can be acquired:

p(x,y)=f3(x2,y2) (10),

where f3 is the registration function corresponding to the affine transformation matrix. The affine transformation is two-dimensional coordinate transformation. Assume that a pixel has the coordinate (x2,y2) before it is subjected affine transformation, and its coordinate after it is subjected to affine transformation is (x,y). Then, the coordinates are transformed by formula (11) and formula (12):

$$\begin{matrix}( \begin{matrix}x \\ y\end{matrix} ) = ( \begin{matrix}{b}_{11} & {b}_{12} & {b}_{13} \\ {b}_{21} & {b}_{22} & {b}_{23}\end{matrix} ) ( \begin{matrix}x 2 \\ y 2 \\ 1\end{matrix} ) , and & ( 11 ) \\ x = {b}_{11} x 2 + {b}_{12} y 2 + {b}_{13} \\ y = {b}_{21} x 2 + {b}_{22} y 2 + {b}_{23} . & ( 12 )\end{matrix}$$

Since the fish-eye distortion removal, viewing angle transformation and registration (affine transformation) described above are all linear, these three operations may be combined—that is, the fusion transformation function f4 of the three pieces of coordination transformation information may be calculated. In this case, the coordinate of the pixel subjected to fusion transformation may be calculated by p(x,y)=f4(x0,y0). From this fusion transformation function, it is possible to derive, for a pixel in the stitched image, its corresponding coordinate in the original input image.

In another example of the image stitching method, the method may further comprise an operation of generating a stitching information table, which is implemented by, for example:

acquiring, based on fusion transformation information from the plurality of images correspondingly captured by the plurality of cameras to the stitched image, a coordinate of the pixel in an input sub-block of a captured image corresponding to a coordinate of each pixel in an output sub-block;

acquiring position information of the input sub-block (such as size and offset address), and overlapping attribute information indicating whether the input sub-block belongs to an overlapping area of any two captured images; and recording, in the stitching information table, relevant information of each output sub-block through an information table sub-block in an order of output sub-blocks. In some embodiments, the relevant information of an output sub-block may include but is not limited to, for example, position information of the output sub-block (e.g., the size of the output sub-block and the offset address of the output sub-block), overlapping attribute information of an input sub-block corresponding to the output sub-block, an identifier of an input image to which an input sub-block corresponding to the output sub-block belongs, a coordinate of each pixel in the output sub-block corresponding to a coordinate of the pixel in an input sub-block, and position information of an input sub-block (e.g., the size of the input sub-block and the offset address of the input block).

The size of an input sub-block is a difference between a maximum value and a minimum value in the coordinates of pixels in the input sub-block. Width w and height h of the input sub-block can be expressed by w=xₘₐₓ−xₘᵢₙ, h=yₘₐₓ−yₘᵢₙ. The offset address of the input sub-block is xₘₐₓ and Yₘₐₓ xₘₐₓ is the maximum value of x coordinates among coordinates of pixels in the input block, xₘᵢₙ is the minimum value of x coordinates among coordinates of pixels in the input block, yₘₐₓ is the maximum value of y coordinates among coordinates of pixels in the input block, and yₘᵢₙ is the minimum value of y coordinates among coordinates of pixels in the input block.

Correspondingly, in this example, acquiring an input image block in an input image corresponding to the output sub-block may comprise: reading out an information table sub-block in sequence from the stitching information table, and acquiring, based on relevant information of the output sub-block recorded in the read information table sub-block, an input image block corresponding to the recorded output sub-block.

According to the examples described above, it is possible to combine lens distortion removal information, viewing angle transformation information, registration information into fusion transformation information, based on which a correspondence between coordinates of pixels in an input image and those in the stitched image can be calculated directly. In this way, one single operation makes it possible to subject an input image to distortion removal, viewing angle transformation and registration, thereby simplifying the calculation and improving the processing efficiency and speed.

In some embodiments, coordinates of pixels can be quantified so that a computation chip can read them. For example, quantifying the x coordinate and y coordinate of a pixel into an eight-bit integer and a four-bit decimal respectively can not only reduce the size of coordinate-represented data by but also represent a more accurate coordinate position. For example, when the coordinate of a pixel in an input image block is (129.1234, 210.4321), the quantified coordinate can be (1000001.0010, 11010010.0111).

When one or more of the plurality of cameras are changed in respect of position and/or direction, the fusion transformation information may change, and information in the stitching information table generated based on the fusion information may also change. Thus, in a further example of the present disclosure, in response to a change in position and/or direction of one or more of the plurality of cameras, the fusion transformation information is acquired again and the stitching information table is regenerated. That is, it is necessary to perform the following again: acquiring fusion transformation information based on various transformation information from the plurality of images correspondingly captured by the plurality of cameras to the stitched image; acquiring, based on fusion transformation information from the plurality of images correspondingly captured by the plurality of cameras to the stitched image, a coordinate of the pixel in an input sub-block of the captured image corresponding to a coordinate of each pixel in an output sub-block; acquiring position information of the input sub-block, and overlapping attribute information indicating whether the input sub-block belongs to the overlapping area of any two input images; and recording, in the stitching information table, relevant information of each output sub-block through an information table sub-block in an order of output sub-blocks.

In another example of the image stitching method of the present disclosure, the method may further comprise: acquiring, based on an overlapping area of a plurality of images correspondingly captured by a plurality of cameras, brightness compensation information of each of the plurality of captured images, and storing it in a stitching information table or information table sub-blocks of a stitching information table.

Correspondingly, in this example, acquiring brightness compensation information of each of the plurality of input images to be stitched may be implemented by: acquiring brightness compensation information of images that are captured by the same camera from the stitching information table or the information table sub-block, as brightness compensation information of a corresponding input image.

In a further example of the present disclosure, the method may comprise: acquiring again brightness compensation information of each of the plurality of captured images when light change in an environment where the plurality of cameras are located meets a predetermined condition, for example, when light change in an environment where the plurality of cameras are located is greater than a preset value. That is, acquiring, based on an overlapping area of a plurality of captured images correspondingly captured by a plurality of cameras, brightness compensation information of each of the plurality of captured images is performed again, and the brightness compensation information of each captured image in the stitching information table is updated by the newly acquired brightness compensation information of each captured image.

In some embodiments, acquiring, based on an overlapping area of a plurality of input images correspondingly captured by a plurality of cameras, brightness compensation information of each of the plurality of captured images may comprise:

acquiring the brightness compensation information of each of the plurality of captured images in such a way that after brightness compensation is performed, the sum of differences in pixel value between every two captured images in the overlapping area of the plurality of captured images is minimized.

Every color image has the three channels of red, green and blue (RGB). In some embodiments, for each channel of a captured image, the brightness compensation information of each of the plurality of captured images in a channel is acquired in such a way that after brightness compensation is performed, the sum of differences in pixel value in the channel between every two captured images in the overlapping area of the plurality of captured images is minimized. That is, in this example, a set of brightness compensation information is acquired for each channel of a captured image, for example, channel R, channel G and channel B, and the set of brightness compensation information includes brightness compensation information of each of the plurality of captured images in the channel. According to this example, it is possible to acquire three sets of brightness compensation information of the plurality of captured images in channel R, channel G and channel B.

For instance, in an optional example, a preset error function is used to represent the sum of differences in pixel value between every two captured images in the overlapping area of the plurality of captured images, and brightness compensation information of each captured image when the error function has a minimum value is acquired. The error function is a function of brightness compensation information of a captured image having the same overlapping area and the pixel value of at least one pixel in the overlapping area.

In some optional examples, acquiring brightness compensation information of each captured image when the error function has a minimum value may be performed by, for each channel of a captured image, acquiring the brightness compensation information of each captured image in the channel when the error function has the minimum value. In this example, the error function is a function of brightness compensation information of a captured image having the same overlapping area and the pixel value of at least one pixel in the overlapping area in the channel.

In an optional example, for the six input images to be stitched in FIG. 2, the error function in one channel is expressed as:

e(i)=(a1*p1−a2*p2)²+(a1*p1−a3*p3)²+(a2*p2−a4*p4)²+(a3*p3−a5*p5)²+(a4*p4−a6*p6)²+(a5*p5−a6*p6)² (13)

where a1, a2, a3, a4, a5, and a6 respectively represent brightness compensation information (also known as brightness compensation coefficient) of the six input images in the channel; p1, p2, p3, p4, p5, and p6 represent averages of pixel values (i.e., R component, G component, B component) of the six input images corresponding to the channel. When e(i) function has the minimum value, the visual difference between the six input images in the channel is the minimum. The example of the present disclosure may use an error function in another form and is not limited to that shown by formula (13).

The function value of one channel may be acquired by:

acquiring, for one channel of a captured image, the sum of absolute values of the weighted differences between pixel values, in an overlapping area, of two input images having the same overlapping area, or the sum of the squares of the weighted differences between pixel values, in an overlapping area, of two input images having the same overlapping area.

The weighted differences between pixel values, in an overlapping area, of two captured images include the difference between a first product and a second product. The first product includes the product of brightness compensation information of a first captured image and the sum of pixel values of at least one pixel in the overlapping area of the first captured image. The second product includes the product of brightness compensation information of a second captured image and the sum of pixel values of at least one pixel in the overlapping area of the second captured image.

According to the examples described above, after relevant information all output blocks is recorded in a stitching information table, when image stitching is performed based on this stitching information table, this table as well as a plurality of input images to be stitched that are captured by a plurality of cameras in real time or in a preset period may be stored in the memory so that this information table and these input images can be read out when they are to be used.

Once a stitching information table is generated, image stitching can be performed, and it does not need be updated unless the light and/or camera position/direction change/changes. With the advantages of short delay and high throughput due to less time spent on image stitching, the image stitching can be done more efficiently, which meets the real-time requirement of panorama stitching in an intelligent vehicle and improves the display frame rate and resolution of a stitched video.

In a possible implementation, the memory may be DDR (Double Data Rate) memory and memories of other types.

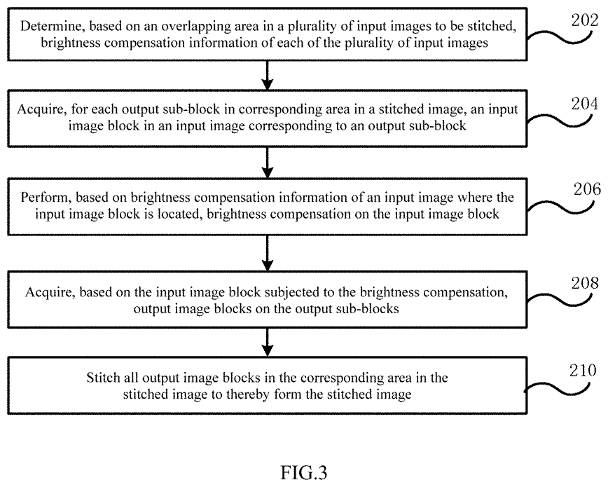

FIG. 3 is a flowchart of another example of an image stitching method according to the present disclosure. As shown in FIG. 3, the method comprises:

step 202 of determining, based on an overlapping area in a plurality of input images to be stitched, brightness compensation information of each of the plurality of input images.

In an optional example, step 202 may be executed by the processor invoking a corresponding instruction stored in the memory, or by a first acquisition module run by the processor.

The method further comprises:

step 204 of acquiring, for each output sub-block in corresponding area in a stitched image, an input image block in an input image corresponding to an output sub-block.

If an input image block corresponding to an output sub-block belongs to an overlapping area, input images blocks in all input images that correspond to the output sub-blocks and have the overlapping area.

In an optional example, step 204 may be executed by the processor invoking a corresponding instruction stored in the memory, or by a second acquisition module run by the processor.

The method further comprises:

step 206 of performing, based on brightness compensation information of an input image where the input image block is located, brightness compensation on the input image block.

In an optional example, step 206 may be executed by the processor invoking a corresponding instruction stored in the memory, or by a compensation module run by the processor.

The method comprises:

step 208 of acquiring, based on the input image block subjected to the brightness compensation, output image block on the output sub-blocks.

If an input image block in an input image corresponding to an output sub-block belongs to an overlapping area, an average, a weighted value, or a weighted average of pixel values of each pixel in at least two different resolutions is acquired for each channel of an output image block, and an output image block is acquired by performing weighted superposition in accordance with the average value, the weighted value, or the weighted average of pixel values of each pixel. The at least two different resolutions include: the resolution of the interpolated input image block and at least one resolution lower than the resolution of the interpolated input image block.

In an optional example, step 208 may be executed by the processor invoking a corresponding instruction stored in the memory, or by a third acquisition module run by the processor.

The method further comprises:

step 210 of stitching all output image blocks in the corresponding area in the stitched image to obtain the stitched image.

In an optional example, step 210 may be executed by the processor invoking a corresponding instruction stored in the memory, or by a stitching module run by the processor.

According to this example, the block-based processing strategy makes it possible to obtain output image blocks respectively and thereby makes it possible to process input images more speedy in an assembly-line-like manner. With short delay and high throughput, the image stitching can be done more efficiently, thereby meeting the real-time requirement of video image stitching.

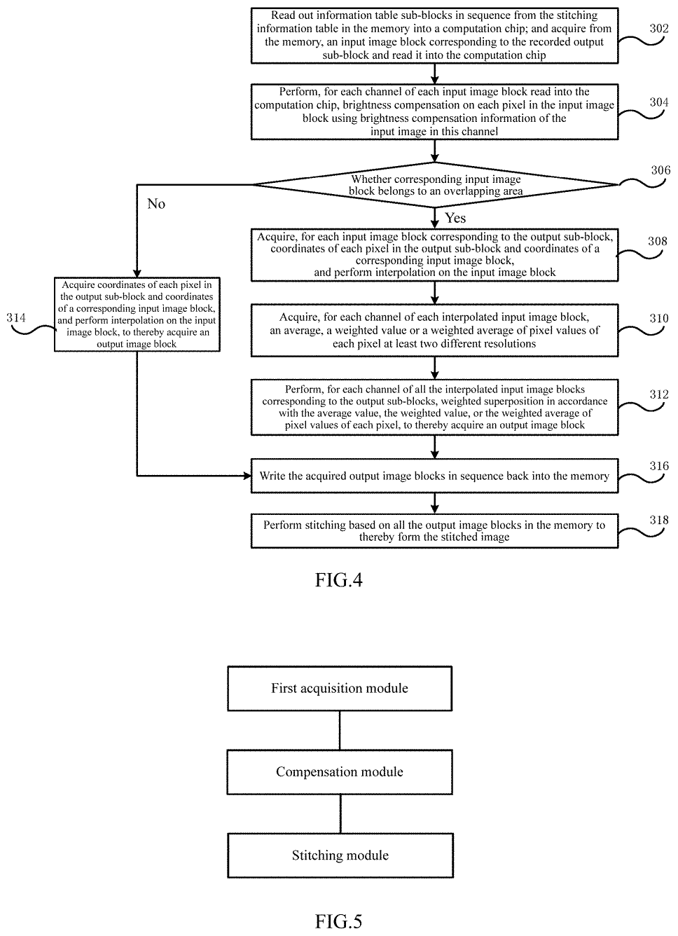

FIG. 4 is a flowchart of still another example of an image stitching method according to the present disclosure. This example further explains an example of the image stitching method according to the present disclosure through the use of generating a stitching information table in advance as an example. As shown in FIG. 4, the image stitching method of this example comprises:

step 302 of reading out information table sub-blocks in sequence from the stitching information table in the memory into a computation chip; and acquiring from the memory, based on relevant information of the output sub-block recorded in the read information table sub-block, an input image block corresponding to the recorded output sub-block and reading it into the computation chip.

If, based on relevant information of the output sub-block recorded in the read information table sub-block, an input image block in an input image corresponding to the output sub-block belongs to an overlapping area, input image blocks in all input images that correspond to the output sub-blocks and have the overlapping area are acquired from the memory and read into the computation chip.

In an optional example, step 302 may be executed by the processor invoking a corresponding instruction stored in the memory, or by a second acquisition module run by the processor.

The method further comprises:

step 304 of performing, for each channel of each input image block read into the computation chip, brightness compensation on each pixel in the input image block using brightness compensation information of the input image in this channel, i.e., performing multiplication processing on a pixel value of each pixel in this channel.

In an optional example, step 304 may be executed by the processor invoking a corresponding instruction stored in the memory, or by a compensation module run by the processor.

The method further comprises:

step 306 of determining, based on relevant information of an output sub-block recorded in an information table sub-block read into the computation chip, whether an input image block in an input image corresponding to the output sub-block belongs to an overlapping area.

If an input image block in an input image corresponding to the output sub-block belongs to an overlapping area, step 308 will be executed; otherwise, step 314 will be executed.

The method further comprises:

step 308 of acquiring, for each input image block corresponding to the output sub-block, coordinates of each pixel in the output sub-block and coordinates of a corresponding input image block, and performing interpolation on the input image block;

step 310 of acquiring, for each channel of each interpolated input image block, an average, a weighted value or a weighted average of pixel values of each pixel in at least two different resolutions,

wherein the at least two different resolutions include: the resolution of the interpolated input image block and at least one resolution lower than the resolution of the interpolated input image block;

step 312 of performing, for each channel of all the interpolated input image blocks corresponding to the output sub-blocks, weighted superposition in accordance with the average value, the weighted value, or the weighted average of pixel values of each pixel, to thereby acquire an output image block,

Step 316 follows step 312;

step 314 of acquiring coordinates of each pixel in the output sub-block and coordinates of a corresponding input image block, and performing interpolation on the input image block, to thereby acquire an output image block; and

step 316 of writing the acquired output image blocks in sequence back into the memory.

In an optional example, steps 306 to 316 may be executed by the processor invoking a corresponding instruction stored in the memory, or by a third acquisition module run by the processor.

The method further comprises:

step 318 of performing, in response to writing all the output image blocks in a stitched image area corresponding to the stitching information table back into the memory, stitching based on all the output image blocks in the memory, to obtain the stitched image.

In an optional example, steps 318 may be executed by the processor invoking a corresponding instruction stored in the memory, or by a stitching module run by the processor.

In some embodiments, the computation chip may be, for example, a Field Programmable Gata Array (FPGA). In the case of an FPGA, in step 302, information table sub-blocks are read in sequence from an information table in the memory and stored in the cache in the FPGA. In steps 304 to 314, the cached data in the FPGA is processed accordingly.

According to the example descried above, it is possible to process images inside an FPGA in an assembly-line-like manner. With short delay and high throughput, it is possible to meet the real-time requirement of video image stitching.

Since input images captured by a plurality of cameras arranged in a vehicle are large and captured in real time, the amount of data stored in the stitching information table is also large.

Since the cache in the FPGA is small, the FPGA takes the block-based processing strategy, and the information table sub-blocks and the corresponding input image blocks are processed after they are read from the memory to the cache, which improves the efficiency of parallel processing of images.

If the area of the output sub-block is small, the bandwidth utilization of the memory will be low. However, since the internal cache capacity of the FPGA is limited, the area of the output sub-block ought not to be too large. In examples of the present disclosure, it is possible to determine the size of the output sub-block by taking into account the efficiency and the cache capacity of the FPGA. In an optional example, the size of the output sub-block is 32×32 pixels.

Since coordinates of pixels in original input images corresponding to coordinates of pixels in the stitched image are locally discrete, output images of one row are not in one row in the same input image captured by the camera. Row buffering refers to a first-in-first-out (FIFO) technology used to improve processing efficiency when processing images row by row. Therefore, if the traditional row buffering method is employed, a large number of images input row-by-row must be read because one row of output images correspond to many rows of input images, a large number of pixels in which are not used. This inevitably leads to low utilization of memory bandwidth and low processing efficiency. Due to the block-based processing method employed in the examples of the present disclosure, the area of the stitched image is divided into blocks, and the corresponding input image and stitching information table are also divided into blocks. When the FPGA performs image stitching, it gradually reads the input image sub-blocks and the information table sub-blocks in the memory, which reduces the amount of data cached by the FPGA and improves the efficiency of image stitching.

According to the examples described above, after the stitched image is obtained, the method may comprise:

displaying the stitched image, or performing collision warning and/or driving control based on the stitched image.

Any one of the image stitching methods provided in the examples of the present disclosure is executable by any suitable device capable of data processing, which includes but is not limited to: terminal devices and servers. Alternatively, any one of the image stitching methods provided in the examples of the present disclosure is executable by a processor. For example, the processor executes any one of the image stitching methods mentioned in examples of the present disclosure by invoking corresponding instructions stored in a memory. Hereinafter the image stitching methods will not be repeated.

It is understandable to a person skilled in the art that all or part of the steps in the method according to any one of the examples described above may be implemented by a program instructing relevant hardware. The program may be stored in a computer readable storage medium. When the program is executed, the steps in the method according to any one of the examples are carried out. The storage medium includes: ROM, RAM, magnetic disk, optical disk, and other media capable of storing program codes.

FIG. 5 is a schematic structural diagram of an example of an image stitching device of the present disclosure. The image stitching device of this example can be used to implement the image stitching method according to any one of the examples of the present disclosure described above. As shown in FIG. 5, the image stitching device of this example comprises: a first acquisition module, a compensation module, and a stitching module.

The first acquisition module is configured to acquire brightness compensation information of each of a plurality of input images to be stitched, wherein the plurality of input images are correspondingly captured by a plurality of cameras.

The plurality of input images are correspondingly captured by the plurality of cameras arranged on different parts of an apparatus. The position and direction of the plurality of cameras are such that least two adjacent images or every two adjacent images in the plurality of input images captured by the plurality of cameras have an overlapping area.

In some embodiments, the apparatus in which the plurality of cameras are arranged may be a vehicle, a robot, or any other apparatus that needs to acquire a stitched image, such as other transportation means. When the apparatus in which the plurality of cameras are arranged is a vehicle, the number of the plurality of cameras may be 4 to 8, depending on the length and width of the vehicle and the cameras' field of view to capture the images.

Thus, in some of the embodiments, the plurality of cameras may include at least one camera arranged at the head position of the vehicle, at least one camera arranged at the rear position of the vehicle, at least one camera arranged at the middle section of one side of the vehicle body, and at least one camera arranged in the middle section of the other side of the vehicle body. Alternatively, the plurality of cameras may include at least one camera arranged at the head position of the vehicle, at least one camera arranged at the rear position of the vehicle, at least two cameras arranged respectively in the front half section and the rear half section of one side of the vehicle body, and at least two cameras respectively arranged in the front half section and the rear half section of the other side of the vehicle body.

In some of the embodiments, the plurality of camera may include at least one fish-eye camera, and/or at least one non-fish-eye camera.

The compensation module is configured to perform brightness compensation on input images based on the brightness compensation information of each input image.

The stitching module is configured to stitch the input images subjected to the brightness compensation to obtain a stitched image.

According to the examples described above, when a plurality of input images correspondingly captured by a plurality of cameras are stitched, brightness compensation information of each of the plurality of input images to be stitched is acquired, brightness compensation is performed on input images based on the brightness compensation information of each input image, and the input images subjected to the brightness compensation are stitched, to obtain a stitched image. In the examples of the present disclosure, performing brightness compensation on a plurality input images to be stitched realizes overall brightness compensation for the images to be stitched, which can alleviate stitching trace in the stitched image due to the difference in brightness of the plurality of input images to be stitched that arises from the difference in light of the environment where the different cameras are located and from the exposure difference between the cameras. Thus, the visual effect of the stitched image is enhanced, conducive to effects of various applications that are based on the stitched image. For example, when the example of the present disclosure is applied to a vehicle, the stitched image acquired for displaying the driving environment of the vehicle helps to improve the accuracy of the intelligent driving control.

In some embodiments, the first acquisition module is configured to determine brightness compensation information of each of the plurality of input images based on an overlapping area in the plurality of input images.

The brightness compensation information of each input image is used such that the brightness difference between the input images subjected to the brightness compensation falls within a preset brightness tolerance range. Alternatively, in some embodiments of the example, the brightness compensation information of the input images is used such that the sum of the differences in pixel values between every two input images in the overlapping area is minimum or less than a preset error value after the brightness compensation.

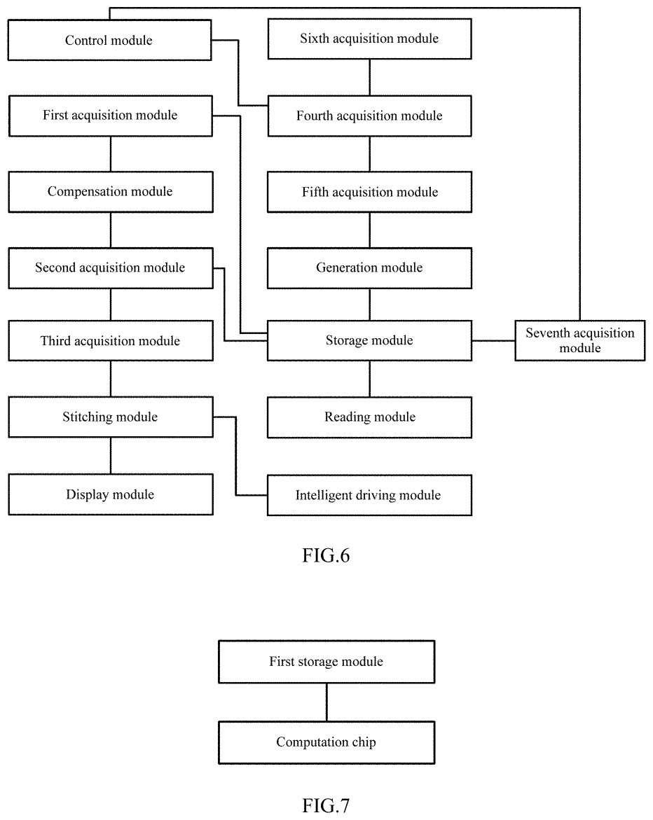

FIG. 6 is a schematic structural diagram of another example of an image stitching device of the present disclosure. As shown in FIG. 6, in comparison with the example shown in FIG. 5, this example further comprises: a second acquisition module configured to acquire, for each output sub-block, an input image block in an input image corresponding to the output sub-block. Correspondingly, in this example, the compensation module is configured to perform, based on brightness compensation information of an input image where the input image block is located, brightness compensation on the input image block.

In some embodiments, when an input image block in an input image corresponding to the output sub-block belongs to an overlapping area of adjacent input images, the second acquisition module is configured to acquire input image blocks in all input images that correspond to the output sub-blocks and have the overlapping area.

In some embodiments, the second acquisition module is configured to acquire position information of the input image block in the input image corresponding to coordinate information of the output sub-block; and to acquire, based on the position information of the input image block, the input image block from the corresponding input image.

In some embodiments, the compensation module is configured to perform, for each channel of the input image block, multiplication processing on pixel values of each pixel in the input image block in a channel by brightness compensation information of the input image in the channel.

With reference to FIG. 6 again, the image stitching device of this example may further comprise: a third acquisition module configured to acquire, based on the input image block subjected to the brightness compensation, output image blocks on the output sub-blocks. Correspondingly, in this example, the stitching module is configured to stitch the output image blocks to obtain the stitched image.

In some embodiments, the third acquisition module is configured to perform, based on a coordinate of each pixel in the output sub-block and a coordinate in a corresponding input image block, interpolation on the input image block to thereby obtain output images block on the output sub-blocks.

In some embodiments, when an input image block corresponding to the output sub-block belongs to an overlapping area of adjacent input images, the third acquisition module is configured to perform, based on a coordinate of each pixel in the output sub-block and a coordinate in a corresponding input image block, interpolation on each of the input image blocks corresponding to the output sub-blocks, and superimpose all the interpolated input image blocks corresponding to the output sub-blocks, to thereby obtain output image blocks.

In an optional example, when superimposing all the interpolated input image blocks corresponding to the output sub-blocks, the third acquisition module is configured to acquire, for each channel of each interpolated input image block, an average, a weighted value or a weighted average of pixel values of each pixel in at least two different resolutions, wherein the at least two different resolutions include: the resolution of the interpolated input image block and at least one resolution lower than the resolution of the interpolated input image block; and to perform, for each channel of all the interpolated input image blocks corresponding to the output sub-blocks, weighted superposition in accordance with the average value, the weighted value, or the weighted average of pixel values of each pixel.

With reference to FIG. 6 again, the image stitching device of this example may further comprise: a fourth acquisition module configured to acquire, based on fusion transformation information from the plurality of images correspondingly captured by the plurality of cameras to the stitched image, a coordinate of a pixel in an input sub-block of an input image corresponding to a coordinate of each pixel in the output sub-block; a fifth acquisition module configured to acquire position information of the input sub-block and overlapping attribute information indicating whether the input sub-block belongs to an overlapping area of any two input images; a generation module configured to record, in a stitching information table, relevant information of each output sub-block through an information table sub-block in an order of the output sub-blocks; and a storage module configured to store the stitching information table. Correspondingly, in this example, the second acquisition module is configured to read in sequence information table sub-blocks from the stitching information table, and acquire, based on the relevant information of the output sub-block recorded in the read information table sub-block, an input image block corresponding to the recorded output sub-block.

The relevant information of the output sub-block includes but is not limited to: position information of the output sub-block, overlapping attribute information of an input sub-block corresponding to the output sub-block, an identifier of an input image to which an input sub-block corresponding to the output sub-block belongs, a coordinate of a pixel in an input sub-block corresponding to a coordinate of each pixel in the output sub-block, and position information of an input sub-block.

With reference to FIG. 6 again, the image stitching device of another example may further comprise: a sixth acquisition module configured to acquire fusion transformation information based on various transformation information from the plurality of images correspondingly captured by the plurality of cameras to the stitched image, wherein the various transformation information includes but is not limited to: lens distortion removal information, viewing angle transformation information, and registration information.

The lens distortion removal information includes fish-eye distortion removal information of an input image captured by a fish-eye camera, and/or distortion removal information of an input image captured by a non-fish-eye camera.

With reference to FIG. 6 again, the image stitching device of another example may further comprise: a control module configured to, when there is a change in position and/or direction of one or more of the plurality of cameras, instruct the fourth acquisition module to acquire, based on fusion transformation information from the plurality of images correspondingly captured by the plurality of cameras to the stitched image, a coordinate of a pixel in an input sub-block of an input image corresponding to a coordinate of each pixel in the output sub-block; instruct the fifth acquisition module to acquire position information of the input sub-block and overlapping attribute information indicating whether the input sub-block belongs to an overlapping area of any two input images; and instruct the generation module to record, in a stitching information table, relevant information of each output sub-block through an information table sub-block in an order of the output sub-blocks.

With reference to FIG. 6 again, the image stitching device of another example may further comprise: a reading module configured to read, after the relevant information of all the output sub-blocks is recorded in the stitching information table, the stitching information table into a memory; and read, into the memory, the plurality of input images to be stitched that are captured by the plurality of cameras. Correspondingly, in this example, the second acquisition module is configured to read out an information table sub-block in sequence from the stitching information table in the memory and read it into a computation chip; and acquire from the memory, based on relevant information of the output sub-block recorded in the read information table sub-block, an input image block corresponding to the recorded output sub-block and read it into the computation chip. The computation chip comprises a compensation module and a stitching module. The stitching module is configured to write the acquired output image blocks in sequence back into the memory; and stitch the stitched image, when writing all the output image blocks in a stitched image corresponding to the stitching information table back into the memory.

With reference to FIG. 6 again, the image stitching device of this example may further comprise: a seventh acquisition module configured to acquire, based on an overlapping area of the plurality of images correspondingly captured by the plurality of cameras, brightness compensation information of each of the plurality of captured images, and store it in the stitching information table or information table sub-blocks of the stitching information table. Correspondingly, in this example, the first acquisition module is configured to acquire brightness compensation information of images that are captured by the same camera from the stitching information table or the information table sub-block of the stitching information table, as brightness compensation information of a corresponding input image.

In a further example, the control module may be configured to instruct the seventh acquisition module, when it is detected that light change satisfies a predetermined condition, to acquire, based on an overlapping area of the plurality of images captured by the plurality of cameras, brightness compensation information of each of the plurality of captured images, and update the brightness compensation information of each captured image in the stitching information table by the newly acquired brightness compensation information of each captured image.

In some embodiments, the seventh acquisition module is configured to acquire the brightness compensation information of each of the plurality of captured images in such a way that after brightness compensation is performed, the sum of differences in pixel value between every two captured images in the overlapping area of the plurality of captured images is minimized.

In some embodiments, the seventh acquisition module is configured to acquire, for each channel of a captured image, the brightness compensation information of each of the plurality of captured images in a channel in such a way that after brightness compensation is performed, the sum of differences in pixel value in the channel between every two captured images in the overlapping area of the plurality of captured images is minimized.

In some embodiments, the seventh acquisition module obtains, for each channel of a captured image, the sum of differences in pixel value in the channel between every two captured images in the overlapping area of the plurality of captured images by: acquiring, for one channel of a captured image, the sum of absolute values of the weighted differences between pixel values, in an overlapping area, of two captured images each having the same overlapping area, or the sum of the squares of the weighted differences between pixel values, in an overlapping area, of two captured images each having the same overlapping area. The weighted differences between pixel values, in an overlapping area, of two captured images include the difference between a first product and a second product; the first product includes the product of brightness compensation information of a first captured image and the sum of pixel values of at least one pixel in the overlapping area of the first captured image, and the second product includes the product of brightness compensation information of a second captured image and the sum of pixel values of at least one pixel in the overlapping area of the second captured image. With reference to FIG. 6 again, the image stitching device of this example may further comprise: a display module configured to display a stitched image; and/or an intelligent driving module configured to perform intelligent driving control based on the stitched image.

FIG. 7 is a schematic structural diagram of an example of an on-board image processing device of the present disclosure. The on-board image processing device of this example may be used to implement the image stitching method according to any one of the examples of the present disclosure described above. As shown in FIG. 7, the on-board image processing device of this example comprises: a first storage module and a computation chip.

The first storage module is configured to store a stitching information table and a plurality of input images correspondingly captured by a plurality of cameras.

The computation chip is configured to acquire, from the first storage module, brightness compensation information of each of the plurality of input images to be stitched; to acquire from the first storage module, for each output sub-block, an input image block in an input image corresponding to the output sub-block; to perform, based on brightness compensation information of an input image where the input image block is located, brightness compensation on the input image block, acquire, based on the input image block subjected to the brightness compensation, output image blocks on the output sub-blocks, and write the acquired output image blocks in sequence back into the first storage module; and to obtain the stitched image, in response to writing all the output image blocks in one stitched image area corresponding to the stitching information table back into a memory.

In some embodiments, the stitching information table comprises at least one information table sub-block that contains brightness compensation information of the plurality of input images and relevant information of each output sub-block. The relevant information of an output sub-block includes: position information of the output sub-block, overlapping attribute information of an input sub-block corresponding to the output sub-block, an identifier of an input image to which an input sub-block corresponding to the output sub-block belongs, a coordinate of each pixel in the output sub-block corresponding to a coordinate of the pixel in an input sub-block, and position information of an input sub-block.

In some embodiments, the first storage module may comprise: a volatile storage module. The computation chip may include: a field programmable gate array (FPGA).

In some embodiments, the first storage module may be configured to store a first application unit and a second application unit. the first application unit is configured to acquire, based on fusion transformation information from the plurality of images correspondingly captured by the plurality of cameras to a stitched image, a coordinate of a pixel in an input sub-block of a captured image corresponding to a coordinate of each pixel in an output sub-block; to acquire position information of the input sub-block and overlapping attribute information indicating whether the input sub-block belongs to an overlapping area of any two captured images; and to record, in a stitching information table, relevant information of each output sub-block through an information table sub-block in an order of the output sub-blocks. The second application unit is configured to acquire, based on an overlapping area of the plurality of images correspondingly captured by the plurality of cameras, brightness compensation information of each of the plurality of captured images, and store it in information table sub-blocks of the stitching information table.

FIG. 8 is a schematic structural diagram of another example of an on-board image processing device of the present disclosure. As shown in FIG. 8, compared with the example shown in FIG. 7, the on-board image processing device of this example may further comprise one or more of the following modules:

a non-volatile storage module configured to store operation support information of the computation chip;

an input interface configured to connect the plurality of cameras and the first storage module, and to write the plurality of input images captured by the plurality of cameras into the first storage module;

a first output interface configured to connect the first storage module and a display screen, and to output the stitched image in the first storage module to the display screen for display; and

a second output interface configured to connect the first storage module and the intelligent driving module, and to output the stitched image in the first storage module to the intelligent driving module so that the intelligent driving module performs intelligent driving control based on the stitched image.

An example of the present disclosure provides an electronic apparatus, the apparatus comprising:

a memory configured to store a computer program; and

a processor configured to execute a computer program stored in the memory, and to implement, when the computer program is executed, the image stitching method according to any one of the examples described above.

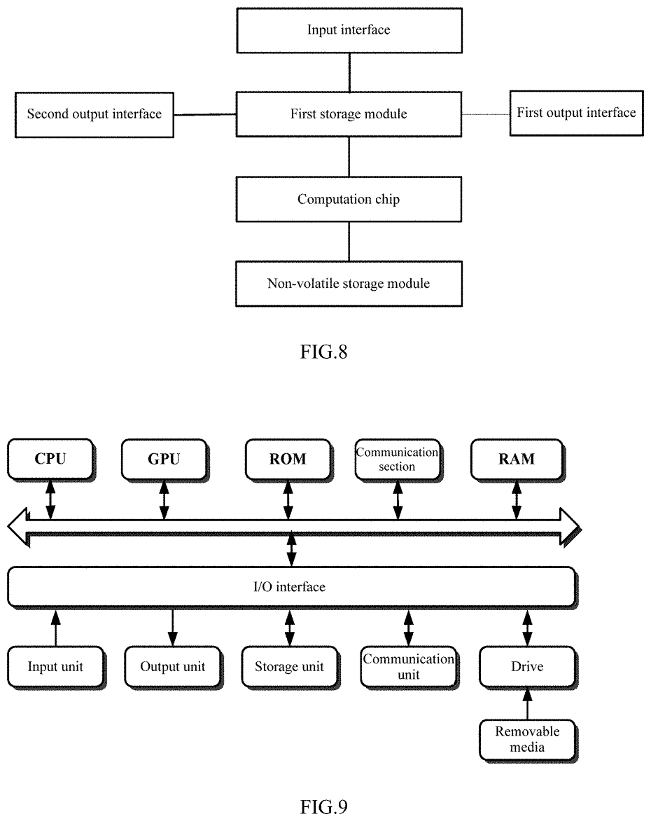

FIG. 9 is a schematic structural diagram of an application example of an electronic apparatus of the present disclosure. FIG. 9 is a schematic structural diagram of an electronic apparatus suitable for implementing a terminal apparatus or server of an example of the present disclosure. As shown in FIG. 9, the electronic apparatus comprises one or more processors, communication sections, etc. The one or more processors are, for example, one or more central processing units (CPUs), and/or one or more graphic processing units (GPUs), etc. The processor can perform various appropriate steps and processing according to executable instructions stored in a read-only memory (ROM) or executable instructions loaded from a storage unit into a random access memory (RAM). The communication section may include but is not limited to a network card, which may include but is not limited to an IB (Infiniband) network card. The processor may communicate with a read-only memory and/or a random access memory to execute executable instructions, is connected to the communication section through a bus, and communicate with other target apparatuses via the communication section, so as to complete the operation corresponding to any image stitching method provided in the examples of the present disclosure, for example, acquire brightness compensation information of each of a plurality of input images to be stitched, wherein the plurality of input images are correspondingly captured by a plurality of cameras arranged on different parts of an apparatus; perform brightness compensation on the input images based on the brightness compensation information of each input image; and stitch the input images subjected to the brightness compensation to obtain a stitched image.

In RAM, various types of programs and data required for device operation can also be stored. CPU, ROM, and RAM are connected to each other through a bus. When an RAM exists, an ROM is an optional module. The RAM stores executable instructions, or writes executable instructions into the ROM during runtime, wherein the executable instructions enable the processor to perform operations corresponding to any one of the image stitching methods of the present disclosure described above. The input/output (I/O) interface is also connected to the bus. The communication section may be an integrated section, or may be configured to have a plurality of sub-modules (such as a plurality of IB network cards) and be installed on the bus link.

The following components are connected to the I/O interface: an input unit including a keyboard, mouse, etc.; a output unit such as a cathode ray tube (CRT), liquid crystal display (LCD), etc., and a speaker; a storage unit including a hard disk; and a communication unit including a network interface card such as an LAN card and modem. The communication unit performs communication processing via a network such as the Internet. The drive may also be connected to the I/O interface as needed. Removable media, such as a magnetic disk, optical disk, magneto-optical disk, semiconductor memory, etc., may be installed on the drive as needed, so that a computer program read from it can be installed into the storage unit as needed.

It should be noted that the architecture shown in FIG. 9 is only an optional implementation. In specific practicing processes, selection, deletion, addition, and replacement may be made for the number and type of the components in FIG. 9 according to actual needs. Different functional components may be set up in a separate or integrated way. For example, the GPU and the CPU can be separated from each other, or the GPU can be integrated on the CPU; the communication section can be separately set, or be integrated on the CPU or GPU; and so on. These alternative embodiments all fall into the protection scope of the present disclosure.

In particular, according to the examples of the present disclosure, the process described above with reference to the flowcharts can be implemented as a computer software program. For example, an example of the present disclosure includes a computer program product, which includes a computer program tangibly contained on a machine-readable medium. The computer program includes program codes for executing the methods shown in the flowcharts. The program codes may include instructions correspondingly executing the steps of the image stitching method provided by any of the examples of the present disclosure. In such an example, the computer program may be downloaded from the network and installed through the communication unit, and/or be installed from a removable medium. When the computer program is executed by the CPU, the functions defined in the image stitching method according to any one of the examples of the present disclosure are executed.

In addition, an example of the present disclosure also provides a computer program, comprising computer instructions which, when run in a processor of an apparatus, implement the image stitching method according to any one of the examples of the present disclosure described above.

In addition, an example of the present disclosure also provides a computer-readable storage medium on which a computer program is stored, wherein when the computer program is executed by a processor, the image stitching method according to any one of the examples of the present disclosure described above is implemented.

The examples of the present disclosure are applicable to the following scenarios:

The examples of the present disclosure are applicable to intelligent vehicle driving scenarios. In assisted driving scenarios, the examples of the present disclosure can be used to perform video panorama stitching to meet stitching effect, real-time and frame rate requirements.

When a driver needs to view the real-time scene around the vehicle, including the scene concerning the blind spot, when the driver's sight is blocked, such as when the driver is reversing the vehicle in a garage or driving on a crowded road, or when the driver is driving on a narrow road, the examples of the present disclosure may display the driver a stitched image.

The examples of the present disclosure, as a part of an intelligent vehicle, provide information for decision-making in intelligent vehicle driving. Intelligent vehicles or self-driving vehicle systems need to perceive the scene around the vehicles to react in real time. The examples of the present disclosure make it possible to implement pedestrian detection and target detection algorithms, and thus possible to automatically control the vehicles to stop or avoid pedestrians or targets in emergencies.

The examples in this specification are described in a progressive manner; each of the examples is focused on its differences from the others, and the same or similar parts between the various examples can be referred to each other. As for the examples of the system, since they basically correspond to the examples of the methods, the description of them is relatively simple. For relevant parts, please refer to the description of the examples of the methods.

The method, device, and apparatus of the present disclosure may be implemented in many ways. For example, the method, device, and apparatus of the present disclosure may be implemented by software, hardware, firmware, or any combination thereof. The orders of the steps in the methods described above are for illustration only, and the steps of the methods of the present disclosure are not limited to the orders described above, unless otherwise specified. In addition, in some examples, the present disclosure may also be implemented as programs recorded in a recording medium, and these programs include machine-readable instructions for implementing the methods of the present disclosure. Thus, the present disclosure also covers a recording medium storing a program for executing the methods of the present disclosure.

The description of the present disclosure is given for the sake of illustration and depiction, and is neither exhaustive nor meant to limit the present disclosure to the disclosed form. Many modifications and changes are obvious to a person skilled in the art. The examples are selected and described in order to better illustrate the principles and practical applications of the present disclosure, and to enable a person skilled in the art to understand the present disclosure so as to design various examples with various modifications suitable for specific purposes.

What is claimed is:

1. An image stitching method, comprising:
acquiring brightness compensation information of each of a plurality of input images to be stitched, the plurality of input images being correspondingly captured by a plurality of cameras arranged on different parts of an apparatus respectively;
performing a brightness compensation on the input images respectively based on the brightness compensation information of each input image; and
stitching the input images subjected to the brightness compensation to obtain a stitched image.

2. The method according to claim 1, wherein at least two adjacent images in the plurality of input images have an overlapping area; or
wherein every two adjacent images in the plurality of input images have an overlapping area

3. The method according to claim 1, wherein the plurality of cameras include: at least one camera arranged at a head position of the vehicle, at least one camera arranged at a rear position of the vehicle, at least one camera arranged at a middle section of one side of a vehicle body, and at least one camera arranged in the middle section of the other side of the vehicle body; or
the plurality of cameras include: at least one camera arranged at the head position of the vehicle, at least one camera arranged at the rear position of the vehicle, at least two cameras arranged respectively in a front half section and a rear half section of one side of the vehicle body, and at least two cameras respectively arranged in the front half section and the rear half section of the other side of the vehicle body.

4. The method according to claim 1, wherein acquiring the brightness compensation information of each of the plurality of input images to be stitched comprises:
determining the brightness compensation information of each of the plurality of input images based an overlapping area in the plurality of input images.

5. The method according to claim 4, wherein the brightness compensation information of each input image is used such that brightness difference between the input images subjected to the brightness compensation falls within a preset brightness tolerance range; or
wherein the brightness compensation information of each input image is used such that the sum of the differences in pixel values between every two input images in the overlapping area subjected to the brightness compensation is minimum or less than a preset error value.

6. The method according to claim 1, wherein performing the brightness compensation on input images respectively based on the brightness compensation information of each input image comprises:
acquiring, for each output sub-block respectively, an input image block in an input image corresponding to the output sub-block; and
performing, based on the brightness compensation information of the input image where the input image block is located, the brightness compensation on the input image block.

7. The method according to claim 6, wherein when the input image block corresponding to the output sub-block belongs to an overlapping area of adjacent input images, acquiring the input image block in the input image corresponding to the output sub-block comprises:
acquiring input image blocks in all input images that correspond to the output sub-blocks and have the overlapping area; or
wherein acquiring the input image block in the input image corresponding to the output sub-block comprises:
acquiring position information of the input image block in the input image corresponding to coordinate information of the output sub-block, and
acquiring, based on the position information of the input image block, the input image block from the corresponding input image.

8. The method according to claim 6, wherein performing, based on the brightness compensation information of the input image where the input image block is located, the brightness compensation on the input image block comprises:
performing, for each channel of the input image block respectively, multiplication processing on pixel values of each pixel in the input image block in the channel by brightness compensation information of the input image in the channel.

9. The method according to claim 6, wherein after performing, based on the brightness compensation information of the input image where the input image block is located, the brightness compensation on the input image block, the method further comprises: performing, based on a coordinate of each pixel in the output sub-block and a coordinate in corresponding input image block, interpolation on the input image block to obtain the output image block on the output sub-block, and
stitching the input images subjected to the brightness compensation to obtain the stitched image comprises: stitching the output image blocks to obtain the stitched image.

10. The method according to claim 9, wherein when the input image block corresponding to the output sub-block belongs to an overlapping area of adjacent input images, performing the interpolation on the input image block to obtain the output image block comprises:
performing the interpolation respectively on each of the input image blocks corresponding to the output sub-blocks, and superimposing all the interpolated input image blocks corresponding to the output sub-blocks, to obtain the output image blocks.

11. The method according to claim 10, wherein superimposing all the interpolated input image blocks corresponding to the output sub-blocks comprises:
acquiring, for each channel of each of the interpolated input image blocks respectively, an average, a weighted value, or a weighted average of pixel values of each pixel in at least two different resolutions, the at least two different resolutions including resolution of the interpolated input image block and at least one resolution lower than the resolution of the interpolated input image block; and
performing, for each channel of all the interpolated input image blocks corresponding to the output sub-blocks respectively, a weighted superposition in accordance with the average value, the weighted value, or the weighted average of the pixel values of each pixel.

12. The method according to claim 9, further comprising:
acquiring, based on fusion transformation information from the plurality of images correspondingly captured by the plurality of cameras to the stitched image, a coordinate of a pixel in an input sub-block of the captured image corresponding to a coordinate of each pixel in the output sub-block;
acquiring position information of the input sub-block and overlapping attribute information indicating whether the input sub-block belongs to an overlapping area of any two captured images; and
recording, in a stitching information table, relevant information of each output sub-block through an information table sub-block in an order of the output sub-blocks,
wherein acquiring the input image block in the input image corresponding to the output sub-block comprises: reading in sequence an information table sub-block from the stitching information table, and acquiring, based on the relevant information of the output sub-block recorded in the read information table sub-block, the input image block corresponding to the recorded output sub-block.

13. The method according to claim 12, wherein the relevant information of the output sub-block includes: position information of the output sub-block, overlapping attribute information of the input sub-block corresponding to the output sub-block, an identifier of the input image to which the input sub-block corresponding to the output sub-block belongs, a coordinate of each pixel in the output sub-block corresponding to a coordinate of a pixel in the input sub-block, and position information of the input sub-block.

14. The method according to claim 12, further comprising:
acquiring fusion transformation information based on various transformation information from the plurality of images correspondingly captured by the plurality of cameras to the stitched image, wherein the various transformation information includes lens distortion removal information, viewing angle transformation information, and registration information; or
further comprising:
in response to a change in position and/or direction of one or more of the plurality of cameras, performing following steps again:
acquiring, based on the fusion transformation information from the plurality of images correspondingly captured by the plurality of cameras to the stitched image, the coordinate of the pixel in the input sub-block of the captured image corresponding to the coordinate of each pixel in the output sub-block,
acquiring the position information of the input sub-block and the overlapping attribute information indicating whether the input sub-block belongs to the overlapping area of any two captured images, and
recording, in the stitching information table, the relevant information of each output sub-block through the information table sub-block in the order of the output sub-blocks; or
further comprising:
reading, after the relevant information of all the output sub-blocks is recorded in the stitching information table, the stitching information table into a memory, and
reading, into the memory, the plurality of input images to be stitched that are captured by the plurality of cameras,
wherein reading in sequence the information table sub-block from the stitching information table, and acquiring, based on the relevant information of the output sub-block recorded in the read information table sub-block, the input image block corresponding to the recorded output sub-block comprise: reading out in sequence the information table sub-block from the stitching information table in the memory and reading it into a computation chip; and acquiring from the memory, based on the relevant information of the output sub-block recorded in the read information table sub-block, the input image block corresponding to the recorded output sub-block and reading it into the computation chip, and
wherein stitching the output image blocks to obtain the stitched image comprises:
writing the acquired output image blocks in sequence back into the memory, and
obtaining the stitched image, in response to writing all the output image blocks of the stitched image corresponding to the stitching information table back into the memory.

15. The method according to claim 12, further comprising:
acquiring, based on an overlapping area of the plurality of images correspondingly captured by the plurality of cameras, brightness compensation information of each of the plurality of captured images, and storing it in the stitching information table or the information table sub-blocks of the stitching information table,
wherein acquiring the brightness compensation information of each of the plurality of input images comprises:
acquiring brightness compensation information of images that are captured by the same camera from the stitching information table or the information table sub-block respectively, as the brightness compensation information of corresponding input image.

16. The method according to claim 15, further comprising:
in response to a light change satisfying a predetermined condition, acquiring again, based on the overlapping area of the plurality of images captured by the plurality of cameras, the brightness compensation information of each of the plurality of captured images; and updating the brightness compensation information of each captured image in the stitching information table by the newly acquired brightness compensation information of each captured image.

17. The method according to claim 15, wherein acquiring, based on the overlapping area of the plurality of images captured by the plurality of cameras, the brightness compensation information of each of the plurality of captured images comprises:
acquiring, for each channel of the captured image respectively, the brightness compensation information of each of the plurality of captured images in the channel in such a way that after the brightness compensation is performed, the sum of differences in pixel values in the channel between every two captured images in the overlapping area of the plurality of captured images is minimized.

18. The method according to claim 17, wherein for each channel of the captured image, the sum of differences in pixel values in the channel between every two captured images in the overlapping area of the plurality of captured images is obtained by:
acquiring, for each channel of the captured image respectively, the sum of absolute values of the weighted differences between pixel values, in an overlapping area, of two captured images each having the same overlapping area, or the sum of the squares of the weighted differences between pixel values, in the overlapping area, of two captured images each having the same overlapping area,
wherein the weighted differences between pixel values, in the overlapping area, of the two captured images include a difference between a first product and a second product; the first product includes a product of the brightness compensation information of a first captured image and the sum of pixel values of at least one pixel in the overlapping area of the first captured image, and the second product includes a second product of the brightness compensation information of a second captured image and the sum of pixel values of at least one pixel in the overlapping area of the second captured image.

19. An electronic apparatus, comprising:
a memory configured to store a computer program; and
a processor configured to execute a computer program stored in the memory, so as to:
acquire brightness compensation information of each of a plurality of input images to be stitched, the plurality of input images being correspondingly captured by a plurality of cameras arranged on different parts of an apparatus respectively;
perform a brightness compensation on the input images respectively based on the brightness compensation information of each input image; and
stitch the input images subjected to the brightness compensation to obtain a stitched image.

20. A non-transitory computer-readable storage medium on which a computer program is stored, wherein when the computer program is executed by a processor, the processor is caused to perform the operations of:
acquiring brightness compensation information of each of a plurality of input images to be stitched, the plurality of input images being correspondingly captured by a plurality of cameras arranged on different parts of an apparatus respectively;
performing a brightness compensation on the input images respectively based on the brightness compensation information of each input image; and
stitching the input images subjected to the brightness compensation to obtain a stitched image.
